(19) United States
(12) Patent Application Publication
(10) Pub. No.: US 2009/0092012 A1
(43) Pub. Date: Apr. 9, 2009

(54) DEVICE AND METHOD OF RECORDING/REPRODUCING INFORMATION INTO/FROM A MEDIUM

(76) Inventor: Kenji Akahoshi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/210,255

(22) Filed: Sep. 15, 2008

(30) Foreign Application Priority Data
Oct. 4, 2007 (JP) 2007-260487

(51) Int. Cl. G11B 20/10

(52) U.S. Cl. 369/47.14

(57) ABSTRACT

A method for recording/reproducing data to/from a medium by which a table is formed for assigning physical addresses of spare areas of the medium to make the physical addresses be continuous with the last address of logical addresses of a user data recording area, and recording/reproducing is performed by using the table. The physical address of an unused spare area is assigned to make the physical address be continuous with the last address of the logical addresses of the user data recording area. It is therefore possible to use the unused spare area as the user data recording area and to effectively utilize the unused spare area.

### INCORPORATION BY REFERENCE

The present application claims priority from Japanese application JP 2007-260487 filed on Oct. 4, 2007, the entire content of which is hereby incorporated by reference into this application.

### BACKGROUND OF THE INVENTION

The present invention relates to a medium recording/reproducing device and a medium recording/reproducing method, and more particularly to a method of efficiently utilizing a spare area not used in a medium uses the spare area for recording/reproducing.

A recording/reproducing device for data recording/reproducing by radiating a laser beam of a semiconductor laser to an optical disk recording medium (hereinafter simply called an optical disc) is known, which is typically a CD Recordable/Rewritable (CD-R/RW) disc, a DVD Recordable/Rerecordable (DVD±R/RW) disc, a DVD-Rewritable (DVD-RAM) disc, a Blu-ray disc and a high definition digital versatile disc (HD-DVD) and the like.

A defect portion may be formed in an optical disc medium of a rewritable type or write once type because of scratch due to partial breakage of the medium, finger print, stain, recording film deterioration and the like. If data is recorded in the defect portion, there is a high possibility that data cannot be reproduced. One method of prolonging a disc lifetime by avoiding a defect portion on a disc surface is a defect management method called “linear replacement”. With “linear replacement”, data is not recorded in the defect portion but is recorded in a spare area (alternative record area) provided in the same optical disk. Related techniques are disclosed in JP-A-2000-100079.

### SUMMARY OF THE INVENTION

The spare area is generally formed on a partial area of a user data recording area, so that an area (capacity) a user can actually record data is reduced by an area (capacity) corresponding to the reserved spare area. If a record error does not occur during recording, the initially reserved spare area is used not at all. The spare area once reserved will not be changed later. This will be described specifically by using a Blu-ray disc as an example. If a spare area is reserved in a write-once type Blu-ray Disc Recordable (BD-R) during format, an assignment ratio between the spare area and a user data recording area will not be changed. Also in a rewritable type Blu-ray Disc Rewritable (BD-RE), if a spare area is reserved once, an assignment ratio between the spare area and a user data recording area will not be changed unless reformat is performed.

Consider now that a case in which a remaining disc capacity becomes small during data recording. Assuming that a remaining disc capacity is X kB although the initially reserved spare area is used very little, if data having a capacity of (X+100) kB is desired to be recorded, this data cannot be recorded because the data capacity to be recorded exceeds the remaining disc capacity. If it is known in advance that the spare area assigned from the user data area is used very little, it is possible to reserve a smaller spare area. However, the spare area cannot be reduced all for nothing from the viewpoint of disc reliability improvement.

It is therefore inevitable to reserve and establish a spare area in advance during format to the extent that disc reliability is not degraded, resulting in a problem that the spare area otherwise usable as the user data recording area is left wastefully.

It is therefore an object of the present invention to effectively utilize a spare area without waste.

This object can be achieved by the invention described in the appended claims. For example, the present invention provides a recording/reproducing device for data recording/reproducing to/from a medium having a spare area and a user data recording area, comprising: a spare area change message processing unit, a spare area management table, a user data logical address management table, a spare area management table reconfiguring unit and a user data logical address management table reconfiguring unit, wherein upon reception, from the spare area change message processing unit, of a message indicating that the spare area is changed to the user data recording area, the user data logical address management table reconfiguring unit assigns a physical address of the spare area to be changed, to make the physical address be continuous with the last address of logical addresses of the user data recording area.

According to the present invention, it is possible to remove a wasteful spare area more than a conventional method.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing the structure of a recording/reproducing device according to an embodiment of the present invention.

FIG. 2 is a diagram showing an overall structure of a BD-R disc.

FIG. 3 is an illustrating diagram showing replacement and logical address reconfiguration.

FIG. 4 is an illustrative diagram showing a user data logical address management table.

### DESCRIPTION OF THE EMBODIMENT

An embodiment of the present invention will now be described with reference to the accompanying drawings.

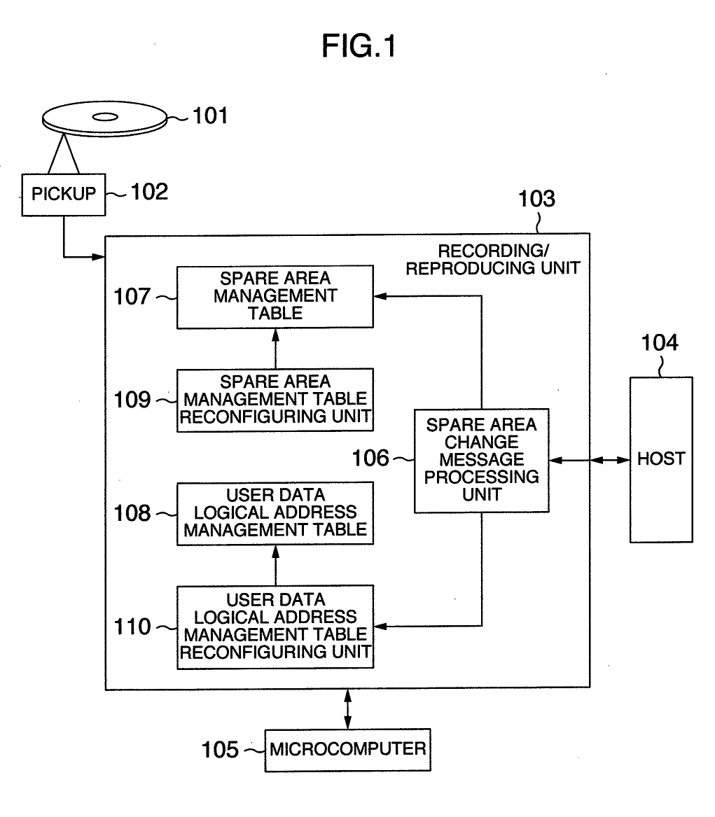

FIG. 1 is a block diagram showing the structure of a recording/reproducing device according to an embodiment of the present invention.

Referring to FIG. 1, a data recordable/reproducible optical disc 101 has a spare area on the disc. A pickup 102 reads a record signal from the optical disc 101. A data recording/reproducing unit 103 is equipped with all units necessary for outputting data from the pickup to an external device host 104 or for recording data from the host 104 in the disc, the units including, although not shown in FIG. 1, a servo control unit for controlling the pickup 102, a data modulation/demodulation unit, an error correction unit, a data temporary storage unit. a temporary storage unit control unit, a host I/F unit for data transfer to/from the host 104 in accordance with a protocol, typically AT Attachment Packet Interface (ATAPI). A microcomputer 105 controls the data recording/reproducing unit. A spare area change message processing unit 106 receives a message output from the host 104 and indicating a change in the spare area. A table 107 manages a spare area on the disc. A table 108 manages a logical address of a user data recording area on the disc. A spare area management table reconfiguring unit 109 reconfigures information on the spare area in the table information of the spare area management table 107 in accordance with the spare area change message. A user data logical address management table reconfiguring unit 110 reconfigures a logical address space of the user data recording area in the table information of the spare area management table 107 in accordance with a spare area change message.

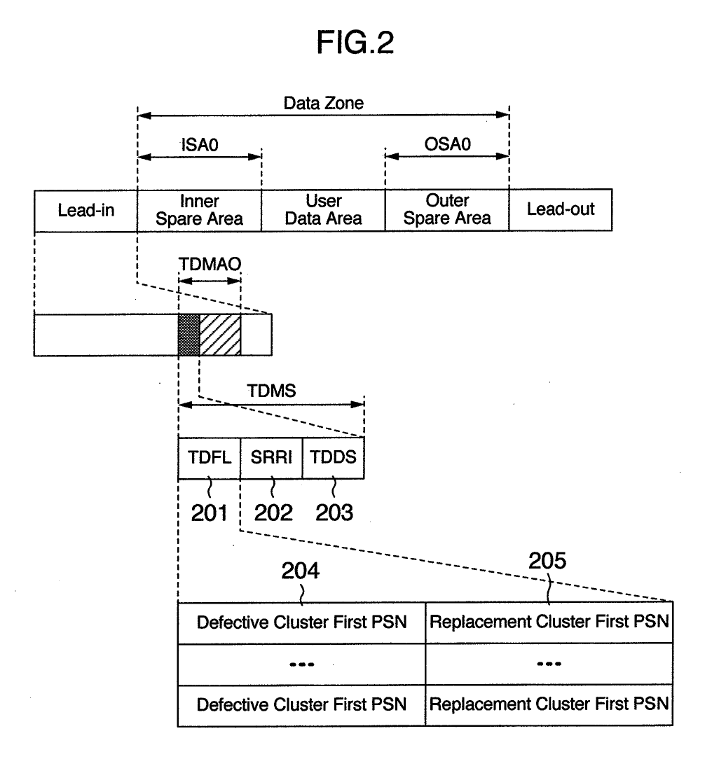

FIG. 2 is a diagram showing the overall structure of a BD-R disc. The disc is constituted of three main areas: a lead-in area, a data zone area and a lead-out area. The data zone area is constituted of an inner spare area 0 (ISA0) which is a spare area in an inner circumferential area, a user data area and an outer spare area 0 (OSA0) which is a spare area in an outer circumferential area. A temporary disc management area (TDMA) for recording management information on recording states exists in the lead-in area, ISA0 area and OSA0 area as represented by TDMA0, TDMA1, and TDMA2, respectively. In this embodiment, for the purposes of description simplicity, TDMA1 and TDMA2 are omitted. The EDMA0 area is constituted of a plurality of temporary disc management structures (TDMSs), and TDMS is one unit of update (recording). TDMS is constituted of a temporary defect list (TDFL) 201, sequential recording range information (SRRI) 202 and a temporary disc definition structure (TDDS) 203. TDFL 201 is used mainly as a list for managing a spare position for a defect on the disc. A defective cluster first PSN 204 for a defect position on the disc is assigned as a spare position of the detect position a replacement cluster first PSN 205. A list of a set of PSNs 204 and 205 can be recorded as many as a TDFL area permits. SRRI 202 contains mainly management information on a recording area corresponding to each track of the disc and called a sequential recording range (SSR). TDDS 203 contains disc management information such as position information of TDFL and capacities of ISA0 and OSA0.

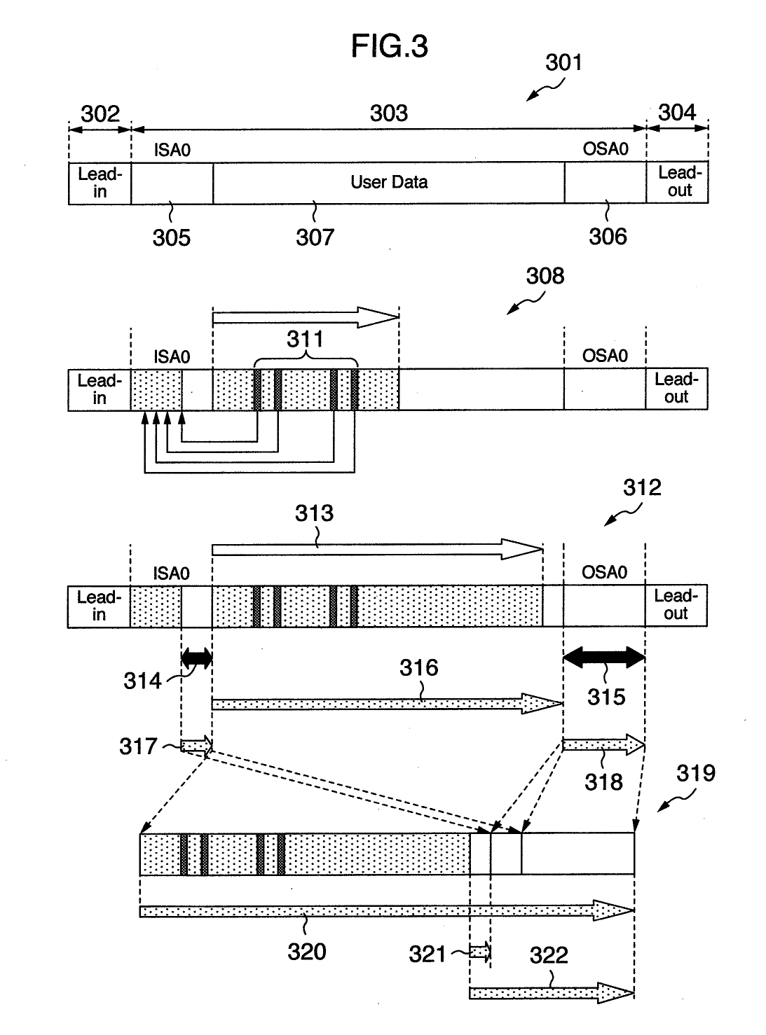

Next, a defect processing method for BD-R will be described with reference to FIG. 3. FIG. 3 is a diagram showing the structure of a disc 301 formatted in the state that the spare areas ISA0 and OSA0 exist. As described with reference to FIG. 2, the disc is constituted of a lead-in area 302, a data area 303 and a lead-out area 304. ISA0 is reserved on the disc inner circumferential side, and OSA0 is reserved on the disc outer circumferential side. These areas are used as spare areas for defects found during data recording, and as other purposes. Therefore, an area 307 capable of recording user data is actually an area obtained by subtracting the areas 305 and 306 from the data area 303. The “user data” used in this specification is not data regarding Universal Disk Format (UDF) and the like, but is intended to mean data a user records consciously, such as music data in a personal computer (PC) and video data taken with a camera.

Next, description will be made on a replacement method for a defect found during recording, with reference to a state 308.

The BD-R spare areas 305 and 306 are reserved during disc format in accordance with a command supplied in advance from the host side (more precisely, a command from an application). In this example, when defect sectors 311 were found during recording continued to an address indicated by a white arrow in the state 308, data replacement was made to the spare area ISA0. Black arrows in the state 308 show an image of correspondence between defect areas and replacement destination areas. TDMA (Temporary Defect Management Area) for recording position information of defect areas and spare areas is reserved in the lead-in area (refer to 201 in FIG. 2). Defective areas of a disc may be formed not only by scratch due to partial breakage of the medium, finger print, stain, recording film deterioration and the like, but also by inherent poor disc quality. If many spare areas are reserved during format, disc reliability can be improved and user merits are obtained because even if many defects are found, data can be recorded in spare areas. However, if many spare areas are reserved, a user data recording area reduces correspondingly and user demerits appear. There is therefore a trade-off relation. Whether spare areas are used in actual data recording depends also upon disc quality, drive performance and data recording environment. From this reason, presently the same spare area capacity is generally reserved uniformly for all media.

The present invention considers that when a remaining disc capacity becomes small during recording, spare areas still not used are changed to the user data recording area. This will be described with reference to FIGS. 1, 3 and 4. It is assumed that recording advances from the state 308 to a state 312 in FIG. 3, i.e., to an address indicated by a white arrow 313. Spare areas not used in the state 312 are spare areas 314 and 315. In this case, when a message is transmitted from the host 104 to the spare area change message processing unit 106, the spare area management table reconfiguring unit 109 and user data logical address management table reconfiguring unit 110 reconfigure each table.

Specific examples of the reconfiguring process will now be described assuming that, for example, the host transmits a message indicating that all spare areas not used are changed to the user data recording area.

A logical address space of the user data recording area before reconfiguration is reserved continuously as indicated by an arrow 316. After reception of the message, an unused area 314 in ISA0 is assigned as logical addresses 317 continuous with the end of the logical address space 316. Further, an unused area 315 of OSA0 is assigned as logical addresses 318 continuous with the end of the logical addresses 317.

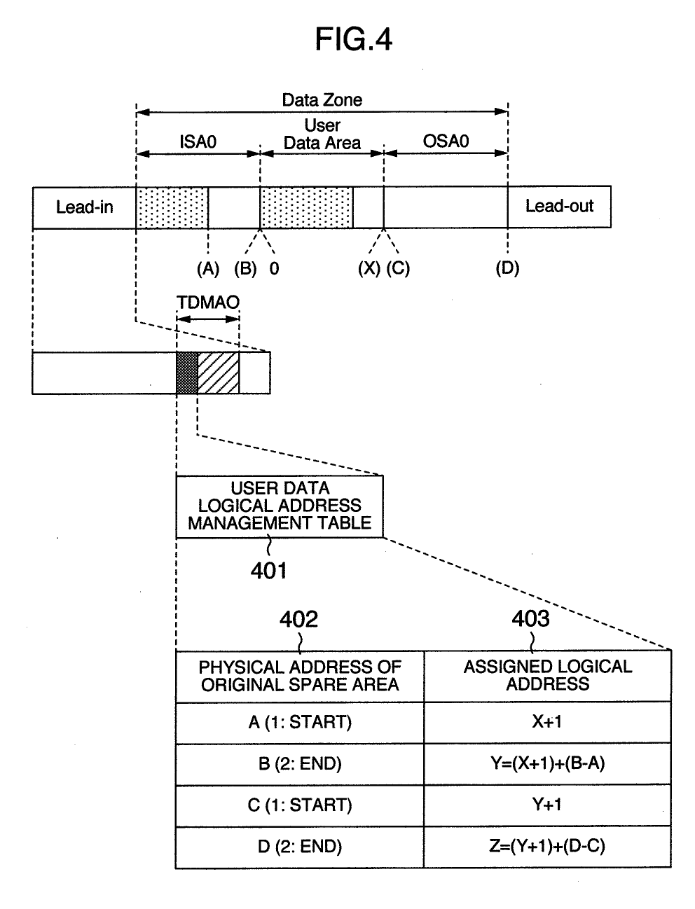

A state 319 shows an image of a logical address space of the whole disc after reconfiguration. A logical address space 320 of the disc indicates that the remaining disc capacity 321 before reconfiguration is expanded to a disc capacity 322. It is therefore possible to effectively utilize the unused spare areas as the user data recording area. A reconfigured user data logical address management table 401 shown in FIG. 4 is newly recorded, for example, in the TDMA0 area. The user data logical address management table is constituted of pairs of physical addresses 402 of an original spare area converted to the user data recording area and assigned logical addresses 403. In this manner, a pair of a physical address of the original spare area and an assigned logical address is registered.

It is obvious that recorded on the medium are information on a physical address of the original spare area changed to the user data recording area, information on a capacity, and all information to be changed which is thereafter changed.

More detailed description will be made on the user data logical address management table. A start physical address of an unused area of ISA0 is represented by A, an end address thereof is represented by B, a start physical address of an unused area of OSA0 is represented by C, an end address thereof is represented by D, a start logical address of the user data recording area is represented by 0, and an end logical address thereof is represented by X. A physical address of an original spare area and a newly assigned logical address are registered in one-to-one correspondence in the user data logical address management table, such as a physical address A and a logical address X+1. In this case, a flag is provided for discriminating between a start and end of physical addresses of an original spate area, 1 indicating the start physical address and 2 indicates the end physical address. This flag is registered in the same field as that of the physical addresses.

With these processes, it becomes possible to change the spare area to the user data recording area, which was not able conventionally. Recording designation from the host is usually logical address designation. For example, if recording to a logical address X+1 is designated, recording starts from the physical address A.

Recording/reproducing can also be made by a different recording/reproducing device by recording the user data logical disc address management table in a disc and reading table information to reconfigure the read logical address.

Lastly, description will be made on a logical disc assignment method and a method for message designation by the host, to be performed by the recording/reproducing device described in this embodiment.

First, description will be made on an example of the logical address assignment method to be performed by the recording/reproducing device. If a medium has spare areas in both the inner and outer circumferential areas of a recording medium, the recording/reproducing device may use either the inner or outer circumferential area to be made continuous with the last logical address. In the above-described embodiment, although the logical address is assigned starting from the inner circumferential spare area, assignment may be made starting from the outer circumferential spare area and then the inner circumferential spare area. Also in a multilayer recording medium and not a single layer recording medium as in the embodiment, all spare areas on the inner circumferential side may be assigned first, and then all spare areas on the outer circumferential side are assigned.

For a multilayer recording medium, all spare areas in the same layer may be assigned first, and then spare areas in different layers are assigned. Also in this assignment method, spare areas may be assigned in the sequential order from a surface side layer to a bottom side layer, or in a random order.

If a serial number can be assigned to all spare areas of a recording medium, a spare area having a spare area serial number designated by the host may be assigned sequentially.

Next, description will be made on an example of the method for message designation by the host. This method includes various host approaches such as designation of a number assigned to each of all spare areas of a recording medium, designation of a physical address range of spare areas, designation of a capacity to be assigned, and designation of a ratio of a remaining spare area capacity to a total spare area capacity. It is obvious that a combination of these approaches is adopted to form a new approach. Other approaches are also possible. Any approach can obtain the same effects as those of this embodiment, if it is possible to form a table for storing correspondence between a physical address of a spare area and a logical address of a user data recording area.

Although the present invention has been described by using a write once type, the invention provides similar effects also for a rewritable type. This is because a difference between the write once type medium and the rewritable type medium resides in that the user data logical address management table is either additionally written or overwritten. It is obvious that the same effects can be obtained for both a single layer type and a multilayer type. The present invention is applicable not only to an optical disc described in the embodiment, but also any other media having a spare area concept, and the same effects can obviously be obtained.

As described so far, according to the present invention, the physical address of an unused spare area is assigned to make the physical address be continuous with the last address of the logical addresses of the user data recording area. It is therefore possible to use the unused spare area as the user data recording area and to effectively utilize the unused spare area.

It should be further understood by those skilled in the art that although the foregoing description has been made on embodiments of the invention, the invention is not limited thereto and various changes and modifications may be made without departing from the spirit of the invention and the scope of the appended claims.

1. A recording/reproducing device for data recording/reproducing to/from a medium having a spare area and a user data recording area, comprising:
spare area change message processing means, a spare area management table, a user data logical address management table, spare area management table reconfiguring means and user data logical address management table reconfiguring means,
wherein upon reception, from said spare area change message processing means, of a message indicating that the spare area is changed to the user data recording area, said user data logical address management table reconfiguring means assigns a physical address of the spare area to be changed, to make the physical address be continuous with the last address of logical addresses of the user data recording area.

2. The recording/reproducing device according to claim 1, wherein said user data logical address management table reconfiguring means records said user data logical address management table in said medium.

3. The recording/reproducing device according to claim 1, wherein said medium is constituted of N layers (N is a positive integer) and has spare areas in each layer, said user data logical address management table reconfiguring means assigns physical addresses of all spare areas of an N-th layer, to make the physical addresses be continuous with the last address of logical addresses of the user data recording area, and thereafter assigns physical addresses of all spare areas of an M-th layer (M is a positive integer different from N), to make the physical addresses be continuous with the logical addresses of the user data recording area added previously.

4. The recording/reproducing device according to claim 1, wherein if said medium has spare areas in both inner and outer circumferential areas, said user data logical address management table reconfiguring means assigns physical address of spare areas on an inner circumferential side, to make the physical addresses be continuous with the last address of the logical addresses of the user data recording area, and thereafter assigns physical addresses of spare areas on an outer circumferential side, to make the physical addresses be continuous with the logical addresses of the user data recording area added previously.

5. The recording/reproducing device according to claim 1, wherein if said medium has spare areas in both inner and outer circumferential areas, said user data logical address management table reconfiguring means assigns physical address of spare areas on an outer circumferential side, to make the physical addresses be continuous with the last address of the logical addresses of the user data recording area, and thereafter assigns physical addresses of spare areas on an inner circumferential side, to make the physical addresses be continuous with the logical addresses of the user data recording area added previously.

6. The recording/reproducing device according to claim 1, wherein if said medium has spare areas at discrete physical addresses and if a number can be assigned to each of the spare areas, said user data logical address management table reconfiguring means assigns physical addresses of spare areas having arbitrary numbers, to make the physical addresses be continuous with the last address of the logical addresses of the user data recording area.

7. The recording/reproducing device according to claim 1, wherein said user data logical address management table reconfiguring means assigns the physical address of spare areas among the spare areas designated by an arbitrary physical address range, to make the physical addresses of the designated spare areas be continuous with the last address of the logical addresses of the user data recording area.

8. The recording/reproducing device according to claim 1, wherein said user data logical address management table reconfiguring means assigns physical addresses of the spare areas having a designated capacity, to make the physical addresses be continuous with the last address of the logical addresses of the user data recording area.

9. The recording/reproducing device according to claim 1, wherein said user data logical address management table reconfiguring means assigns physical addresses of the spare areas having a capacity designated by a ratio of a remaining spare area capacity to a total spare area capacity, to make the physical addresses be continuous with the last address of the logical addresses of the user data recording area.

10. The recording/reproducing device according to claim 1, wherein upon reception, at the device, of an instruction of changing the spare areas to the user data recording area, said spare area management table reconfiguring means deletes addresses of the spare areas converted to the user data recording area, capacity information, and information on presence/absence of the spare areas, to update spare area management information by using the left spare areas.

11. A recording/reproducing method for data recording/reproducing to/from a medium having a spare area and a user data recording area,
wherein upon reception of a message indicating that the spare area is changed to the user data recording area, a physical address of the spare area to be changed, is assigned to make the physical address be continuous with the last address of logical addresses of the user data recording area.

12. The recording/reproducing method according to claim 11, wherein a user data logical address management table is recorded in said medium.

13. The recording/reproducing method according to claim 11, wherein said medium is constituted of N layers (N is a positive integer) and has spare areas in each layer, physical addresses of all spare areas of an N-th layer are assigned to make the physical addresses be continuous with the last address of logical addresses of the user data recording area, and thereafter physical addresses of all spare areas of an M-th layer (M is a positive integer different from N) are assigned to make the physical addresses be continuous with the logical addresses of the user data recording area added previously.

14. The recording/reproducing method according to claim 11, wherein if said medium has spare areas in both inner and outer circumferential areas, physical address of spare areas on an inner circumferential side are assigned to make the physical addresses be continuous with the last address of the logical addresses of the user data recording area, and thereafter physical addresses of spare areas on an outer circumferential side are assigned to make the physical addresses be continuous with the logical addresses of the user data recording area added previously.

15. The recording/reproducing method according to claim 11, wherein if said medium has spare areas in both inner and outer circumferential areas, physical address of spare areas on an outer circumferential side are assigned to make the physical addresses be continuous with the last address of the logical addresses of the user data recording area, and thereafter physical addresses of spare areas on an inner circumferential side are assigned to make the physical addresses be continuous with the logical addresses of the user data recording area added previously.

16. The recording/reproducing method according to claim 11, wherein if said medium has spare areas at discrete physical addresses and if a number can be assigned to each of the spare areas, physical addresses of spare areas having arbitrary numbers are assigned to make the physical addresses be continuous with the last address of the logical addresses of the user data recording area.

17. The recording/reproducing method according to claim 11, wherein the physical addresses of spare areas among the spare areas designated by an arbitrary physical address range are assigned to make the physical addresses of the designated spare areas be continuous with the last address of the logical addresses of the user data recording area.

18. The recording/reproducing method according to claim 11, wherein physical addresses of the spare areas having a designated capacity are assigned to make the physical addresses be continuous with the last address of the logical addresses of the user data recording area.

19. The recording/reproducing method according to claim 11, wherein physical addresses of the spare areas having a capacity designated by a ratio of a remaining spare area capacity to a total spare area capacity are assigned to make the physical addresses be continuous with the last address of the logical addresses of the user data recording area.

20. The recording/reproducing method according to claim 11, wherein upon reception of an instruction of changing the spare areas to the user data recording area, addresses of the spare areas converted to the user data recording area, capacity information, and information on presence/absence of the spare areas are deleted to update spare area management information by using the left spare areas.
